(19) United States
(12) Patent Application Publication
(10) Pub. No.: US 2004/0165629 A1
(43) Pub. Date: Aug. 26, 2004

(54) Current drive device control circuit and solid laser apparatus using the same

(75) Inventor: Mitsuo Iwakura, Tokyo (JP)

Correspondence Address: LINIAK, BERENATO & WHITE, Suite 240, 6550 Rock Spring Drive, Bethesda, MD, 20817, US

(73) Assignee: ORC MANUFACTURING CO., LTD.

(21) Appl. No.: 10/784,818

(22) Filed: Feb. 24, 2004

(30) Foreign Application Priority Data
Feb. 26, 2003 (JP) 2003-049364

(51) Int. Cl. H01S 3/00

(52) U.S. Cl. 372/38.02

(57) ABSTRACT

A current drive device control circuit for controlling drive currents that flow in a plurality of current drive devices serially connected to a constant current power source is characterized by comprising a plurality of bypass circuits parallely connected to each of the plurality of the current drive devices, wherein each of the plurality of the bypass circuits controls a bypass current flowing in own circuit thereof and the drive currents of the current drive devices corresponding to the bypass circuits whose bypass currents are controlled.

### BACKGROUND OF THE INVENTION

1. Field of the Invention

The present invention relates to a current drive device control circuit for controlling a plurality of current drive devices serially connected to a constant current power source and a solid laser apparatus where the circuit is used.

2. Description of the Related Art

Conventionally, as a solid laser apparatus for exciting a solid laser medium by a light, commencing with Nd³⁺: YAG (Y₃Al₅O₁₂), Nd³⁺: YVO₄ or the like, the apparatus excited by a laser diode where light absorption efficiency to the solid laser medium is high compared to a lamp is proposed. Particularly, having a linear light-emission distribution specific for the laser diode, many solid laser apparatuses, which are called a side excitation solid laser apparatus that arranges a plurality of laser diodes on a side of a long solid laser medium along a laser oscillation beam axis, are proposed as an excitation system that is excellent in consistency of a light emitting source and the solid laser medium seen from respective shapes; and such the side excitation solid laser apparatuses are preferably manufactured (see Japanese Patent Laid-Open Publication No. Hei 7-106682).

Using the laser diode for exciting the solid laser medium as described above, the light emitting source is downsized and the solid laser apparatus whose efficiency is high and whose life is also long can be provided. But an excitation condition of the solid laser medium is subject to an excitation light amount from the laser diode. That is, since a difference occurs in the excitation light amount of each of laser diodes due to variations of electric characteristics of the laser diodes and their changes over time, resultingly the excitation condition of the solid laser medium is influenced. Accordingly, in order to uniform the excitation light amount of each of the laser diodes, it is necessary to individually control a drive current of each of the laser diodes where the difference occur.

However, in a solid laser apparatus conventionally utilized in general, a plurality of laser diodes for excitation are simply connected in serial, and all currents of a serial condition thereof are nothing, but are monitored/controlled. FIG. 5 is a drawing showing one example of a conventional current drive device control circuit where a plurality of laser diodes are serially connected. That is, as shown in FIG. 5 a plurality of laser diodes LD1 to LDn for exciting a solid laser medium are serially connected between a constant current power source D0′ (hereinafter simply referred to as the power source), which is a constant current supply source, and a grounding. In addition, between the laser diode LDn and the grounding is provided a drive current sensor CS0′ for detecting a drive current of the laser diodes LD1 to LDn serially connected, and the drive current sensor CS0′ measures a current flowing therein.

And a sensor detection current IS0′ proportional to the measured current by the drive current sensor CS0′ is supplied to one input terminal 2 of a comparator A0′. In addition, a reference signal I0′ corresponding to a predetermined current is input in the other input terminal 1 of the comparator A0′. Accordingly, such a control signal IC0′ to compensate an error between the sensor detection current IS0′ and the reference signal I0′ is supplied to the power source D0′. Thus, the power source D0′ controls a current flowing in the laser diodes LD1 to LDn to a predetermined drive current ID0′. Accordingly, the same drive current ID0′ results in being always supplied to each of the laser diodes LD1 to LDn.

In addition is also known a solid laser apparatus where an excitation circuit for operating a plurality of laser diodes are provided by parallely arranging the laser diodes for excitation at individual circuits, respectively. FIG. 6 is a drawing showing one example of a conventional current drive device control circuit for individually driving a plurality of laser diodes.

As shown in FIG. 6, in a case of a solid laser apparatus where each of the laser diodes LD1 to LDn is arranged at each circuit, at each of the laser diodes LD1 to LDn are respectively and independently arranged each of power sources D1′ to Dn′, each of drive current sensors CS1′ to CSn′, and each of comparators A1′ to An′.

In accordance with such the configuration, reference signals I1′ to In′ corresponding to a predetermined current value and sensor detection signals IS1′ to ISn′ output from each of the drive current sensors CS1′ to CSn′ are also supplied to each of the comparators A1′ to An′, respectively. Accordingly, each of control signals IC1′ to ICn′ is supplied to each of the power sources DI′ to Dn′ from each terminal 3 of independent each of the comparators A1′ to An′, respectively. Therefore, drive currents ID1′ to IDn′ independent of each of the power sources D1′ to Dn′ result in flowing in the respective laser diodes LD1′ to LDn′ (see claims in Japanese Patent Laid-Open Publication No. Hei 11-135860).

However, in accordance with a system of the current drive device control circuit for serially driving the laser diodes as shown in FIG. 5, since when the sensor detection signal IS0′ of the drive current sensor CS0′ and the reference signal I0′ indicating a reference current value are supplied to the comparator A0′, the power source D0′ is controlled in a lump by the control signal IC0′ output from the output terminal 3 of the comparator A0′, thus the same drive current ID0′ flows in all the laser diodes LD1 to LDn. That is, the drive current of each of the laser diodes LD1 to LDn cannot be individually controlled. Therefore, where there are variations of electric characteristics in each of the laser diodes LD1 to LDn, variations occur in an excitation light to a solid laser medium not shown, and resultingly, such a problem that the excitation of the solid laser medium cannot bring out predetermined characteristics occurs.

In addition, in accordance with another system of the current drive device control circuit for driving laser diodes as shown in FIG. 6, since circuit components such as power sources, current sensors, and comparators increase depending on a number of drive circuits, the control circuit results in being enlarged and a cost thereof results in an increase. Furthermore, since a voltage that is necessary at minimum for normally operating each current drive device control circuit is demanded for each of the power sources D1′ to Dn′, for example, provided that a drive current of each of laser diodes LD1 to LDn is 30 A to 50 A and a minimum voltage needed by each of the power sources D1′ to Dn′ is 0.7 V, electric power of 21 W to 35 W is demanded for each the current drive device control circuit.

In other words, in a case of the system where the electric power is independently supplied to each of the laser diodes LD1 to LDn as in FIG. 6, n-fold electric power results in being demanded with being compared to another system where the laser diodes are serially connected as in FIG. 5. Furthermore, since current supply sources (that is, power source) and laser diodes are generally separated, it is necessary to connect a distance between each of the power sources D1′ to Dn′ and each of the laser diodes LD1′ to LDn′ through a cable that can supply a large current. That is, a capacity of the cable of the drive system also results in becoming an n-fold capacity of that of the serial drive system. With such the things being combined, the drive system of the current drive device control circuit as in FIG. 6 results in being jumboized, and an apparatus comprising the control circuit results in increasing more and more in cost.

### SUMMARY OF THE INVENTION

The present invention is found, taking such the situation described above into consideration, and an exemplary object of the invention is to enable a current flowing in each current drive device to be individually controlled by a comparatively simple circuit configuration, and to provide a current drive device control circuit whose consumption electric power is less.

In order to achieve the object, the current drive device control circuit of a first aspect of the present invention, which circuit controls drive currents that flow in a plurality of current drive devices serially connected to a constant current power source, is configured so that the circuit comprises a plurality of bypass circuits parallely connected to each of the plurality of the current drive devices, wherein each of the plurality of the bypass circuits controls a bypass current that flows in own circuit thereof, and the drive currents of the current drive devices corresponding to the bypass circuits whose bypass currents are controlled.

In accordance with the current drive device control circuit of the first aspect of the present invention, when the plurality of the current drive devices are serially connected to the constant current power source, a drive current flowing in a corresponding current drive device can be variably controlled if a current flowing in a bypass circuit provided for each of the current drive devices is controlled. Thus, even when there are variations of electric characteristics in each of the current drive devices, the variations can be compensated if the current flowing in the bypass circuit is controlled.

The current drive device control circuit of a second aspect of the present invention, which circuit controls drive currents that flow in a plurality of current drive devices serially connected to a constant current power source, is configured so that the circuit comprises a plurality of bypass circuits parallely connected to each of the plurality of the current drive devices; a plurality of current detection means for detecting any of a bypass current flowing in each of the plurality of the bypass circuits and a drive current flowing in each of the drive current devices; a plurality of comparative control means for generating a control signal by comparing a detection signal corresponding to a detection current detected by each of the plurality of the current detection means with a reference signal for deciding a reference level of the drive current; and a current control means for controlling the bypass current that flows in a corresponding bypass circuit out of the plurality of the bypass circuits, based on a level of the control signal output by each of the plurality of the comparative control means.

In accordance with the configuration of the current drive device control circuit of the second aspect of the present invention, since each of the current detection means detects any of the bypass current that flows in the corresponding bypass circuit and the drive current that flows in the corresponding current drive device, and sends out the control signal to the current control means, the bypass current of the bypass circuit can be controlled by the current control means. In other words, a total current of each of the drive currents and each of the bypass currents is constant, so if each of the current control means increases/decreases the bypass current of the bypass circuit, depending on the electric characteristics of each of the current drive devices, the drive current that flows in each of the current drive devices is complimentarily increased/decreased. Therefore, the drive current can be controlled to a predesired value. Thus, variations of all the current drive devices serially connected can be compensated.

In addition, the current drive device control circuit of a third aspect of the present invention is, in addition to the configuration described in the second aspect of the invention, characterized by further comprising a composite current detection means for detecting a composite current of drive currents that flow in a plurality of current drive devices and bypass currents that flow in a plurality of bypass circuits; and a composite current comparative control means for generating a composite control signal by comparing a composite detection signal corresponding to a composite current detected by the composite current detection means with a composite reference signal for deciding a reference level of the composite current, wherein a constant current power source controls a current amount supplied to the plurality of the current drive devices, based on a level of the composite control signal output by the composite current comparative control means.

In accordance with the configuration of the current drive device control circuit of the third aspect of the present invention, the constant current power source can be controlled by detecting the composite current of the plurality of the current drive devices serially connected to the constant current power source. Thus, a total current balance of the current drive device control circuit can be taken by always controlling a current supplied from the constant current power source to the plurality of the current drive devices at a predesired value.

Still in addition, the current drive device control circuit of a fourth aspect of the present invention is characterized in that each of the plurality of the current drive devices configured in each aspect of the invention described above is a laser diode. That is, although the laser diode is preferably used as a light emitting source, if there are variations of electric characteristics in the laser diode, the variations occur in a light-emission amount of each the laser diode. Consequently, if a bypass current of each of the bypass circuits is controlled by the current drive device control circuit of the present invention, depending on the variations of each the laser diode, a drive current of each the laser diode can be individually controlled.

Furthermore, the current drive device control circuit of a fifth aspect of the present invention is characterized by comprising a plurality of optical detection means for individually detecting a light-emission amount that each of a plurality of laser diodes emits, wherein at least one current control means out of a plurality of current control means is controlled, based on a level of a light amount detected by each of the plurality of the optical detection means, and wherein the current control means makes a current amount of a bypass current, which flows in a corresponding circuit, variable.

In other words, in accordance with the current drive device control circuit of the fifth aspect of the present invention, the light-emission amount of each of the laser diodes is individually detected by each corresponding optical detection means. Accordingly, when the light-emission amount varies due to the variations of the electric characteristics of the laser diodes and the like, a bypass current of a relevant bypass circuit can be made variable by controlling a relevant current control means with an optical detection signal from a relevant optical detection means. Thus, by controlling a drive current of a relevant laser diode at a predesired value, the variations of the light-emission amount can be compensated.

Still furthermore, the current drive device control circuit of a sixth aspect of the present invention is, in the configuration comprising the plurality of the optical detection means in accordance with the fifth aspect of the invention, characterized in that the constant current power source is controlled, based on a level of a light amount detected by each of the plurality of the optical detection means, and thus a current amount supplied to the plurality of the laser diodes by the constant current power source is made variable. That is, in accordance with the current drive device control circuit of the sixth aspect of the present invention, while comparing/detecting a light-emission amount of each of the laser diodes, mutual optical detection means control the constant current power source. Thus, a total light-emission balance of the laser diodes can be taken by making the current amount, which is supplied from the constant current power source to the plurality of the laser diodes, variable.

Yet furthermore, in the current drive device control circuit of a seventh aspect of the present invention each of the plurality of the current control means is configured of an FET (Field Effect Transistor), wherein the FET is characterized in that: a drain is connected to an anode of a corresponding laser diode out of the plurality of the laser diodes; a source is connected to a cathode of the laser diode; and a gate is connected to an output terminal of a corresponding comparative control means out of the plurality of the comparative control means. That is, in accordance with the current drive device control circuit of the seventh aspect of the present invention, the current control means are configured of the FETs, and a detection signal of any of a bypass current and a drive current is supplied to the gate of the FET, whereby a current amount of the bypass current is controlled with an extremely simple circuit configuration, and thus the drive current of each of the laser diodes can be controlled at a predesired value.

Meanwhile, the plurality of the laser diodes in the current drive device control circuit of the fourth to seventh aspects of the present invention may be arranged at a circumference of a solid laser medium and may be made a solid laser apparatus so that the solid laser medium is excited by excitation lights from another plurality of the laser diodes. In addition, the plurality of the laser diodes in the current drive device control circuit of the fourth to seventh aspects of the present invention may also be arranged at circumferences of solid laser media linearly arrayed and may be made another solid laser apparatus configured so that the solid laser media are excited by excitation lights from still another plurality of the laser diodes.

Thus configured, the solid laser apparatus can radiate balanced excitation lights at a side thereof even when there are variations due to an electric cause; and additionally, can radiate the balanced excitation lights at the side of the solid laser apparatus linearly arrayed.

Meanwhile, the current drive device means a current drive type of a two-terminal device such as a diode, the laser diode, a lamp, and a coil.

### BRIEF DESCRIPTION OF THE DRAWINGS

FIG. 1 is a configuration drawing of a control circuit of a current drive device control circuit, where a plurality of laser diodes are serially connected, in an embodiment of the present invention.

FIG. 2 is a circuit drawing showing an FET as a current control means of a bypass circuit in FIG. 1.

FIG. 3 is a schematic drawing showing one example of a solid laser apparatus of the present invention comprising the current drive device control circuit shown in FIG.1.

FIG. 4 is a schematic drawing showing another example of a solid laser apparatus of the present invention comprising the current drive device control circuit shown in FIG.1.

FIG. 5 is a drawing showing one example of a conventional current drive device control circuit where a plurality of laser diodes are serially connected.

FIG. 6 is a drawing showing one example of a conventional current drive device control circuit where a plurality of laser diodes are individually and parallely driven.

### DESCRIPTION OF THE PREFERRED EMBODIMENTS

Hereinafter, embodiments of the present invention will be described. Here, a case where a suitable laser diode is used as a current drive device for a solid laser apparatus will be described in detail, focusing on a current drive device control circuit.

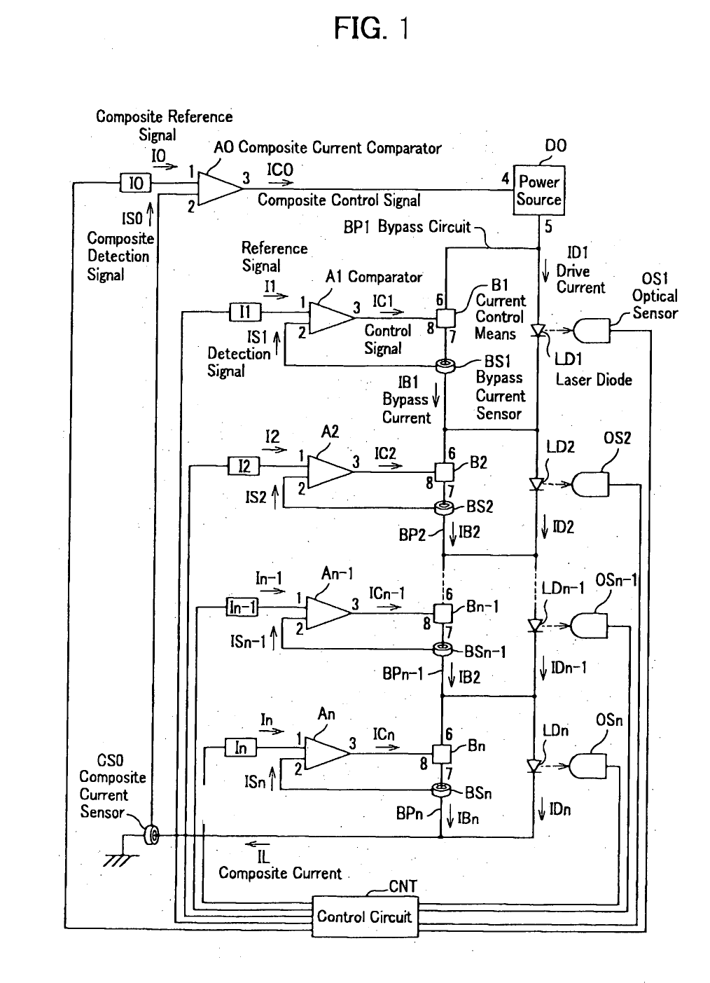

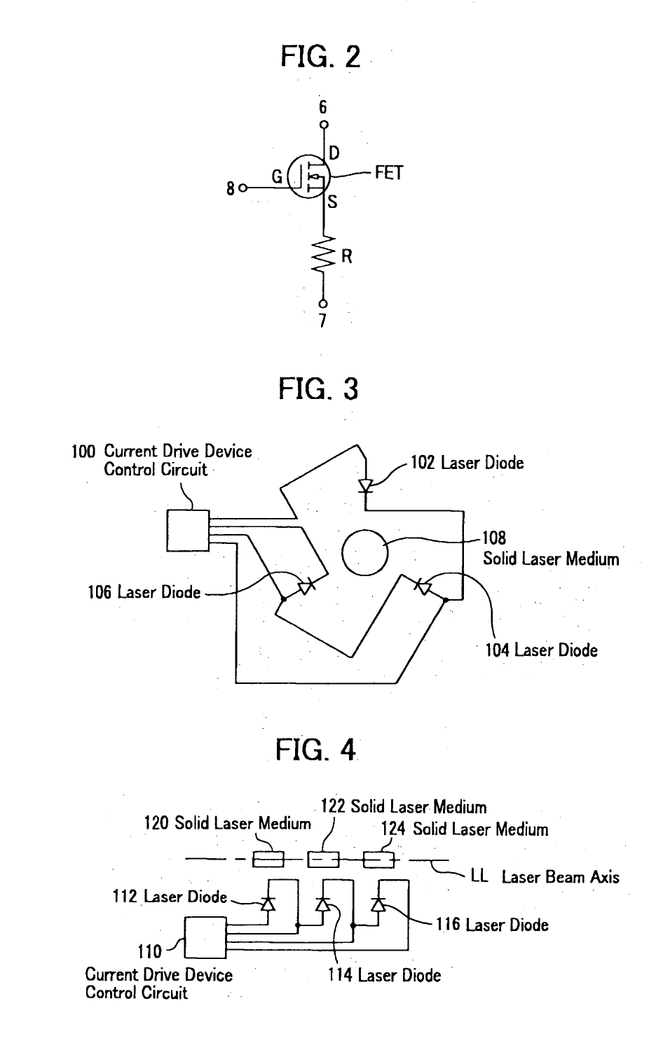

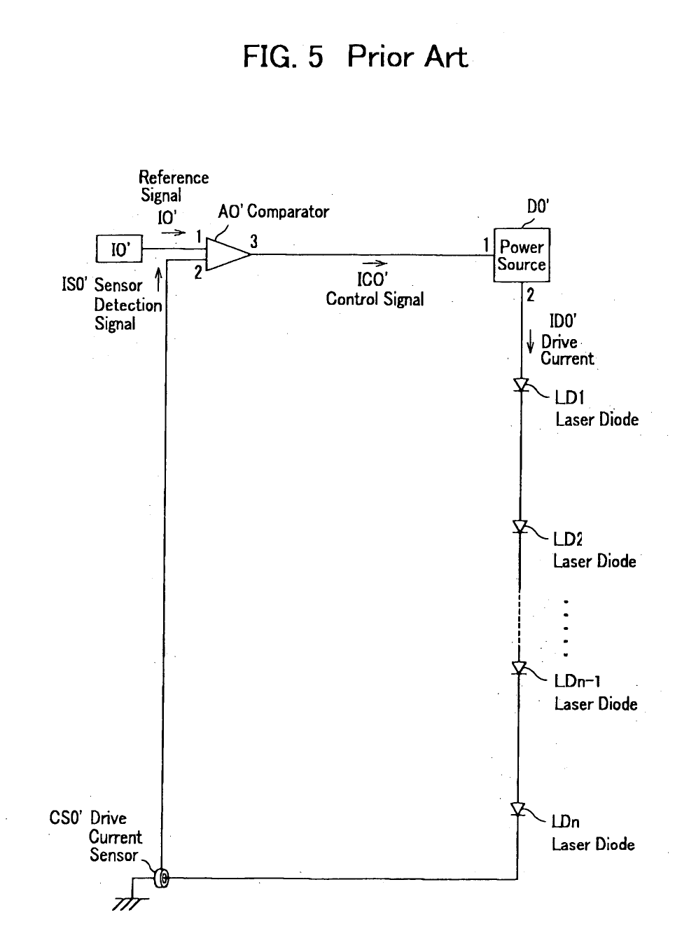

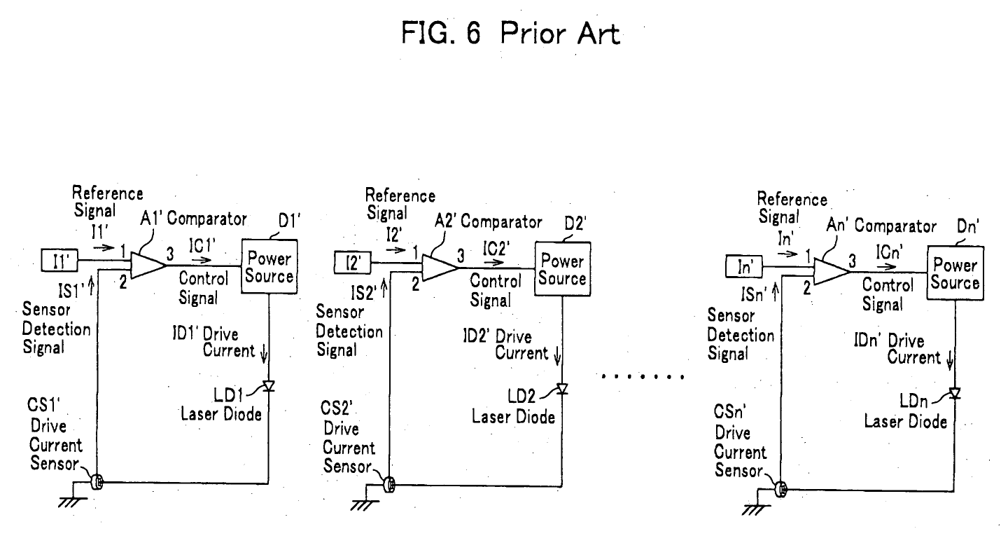

FIG. 1 is a configuration drawing of a control circuit of a current drive device control circuit, where a plurality of laser diodes are serially connected, in an embodiment of the present invention. In FIG. 1 laser diodes LD1 to LDn that are n-pieces (n is an integer more than one) of current drive devices are serially connected between a constant current power source (hereinafter referred to as the power source) Do and a grounding, and bypass circuits BP1 to BPn are parallely connected to the laser diodes LD1 to LDn, respectively. The bypass circuits BP1 to BPn have current control means B1 to Bn, respectively. Meanwhile, each of the current control means B1 to Bn is configured of the FET as shown in FIG. 2.

Each of the current control means B1 to Bn is connected to an anode of each of the laser diodes LD1 to LDn from a drain (D) of each of the FETs through a terminal 6, and is connected to a cathode of each of the laser diodes LD1 to LDn from a source (S) via a bias resistance R through a terminal 7. Meanwhile, a gate (G) of each of the FETs is connected to an output terminal 3 of each of comparators (comparative control means) A1 to An through a terminal 8.

In addition, in each of the bypass circuits BP1 to BPn is provided corresponding each of bypass current sensors (bypass current detection means) BS1 to BSn for detecting a current flowing in a circuit thereof. That is, in each of the bypass circuits BP1 to BPn a negative feedback circuit is configured of each of the bypass current sensors BS1 to BSn and each of the comparators A1 to An.

Each of the comparators A1 to An is provided, depending on a number of the bypass circuits BP1 to BPn, and has a first terminal 1, a second terminal 2, and a third terminal 3. In the first terminal 1 of each of the comparators A1 to An is input a reference signal (any of I1 to In) corresponding to a current reference value of a relevant bypass circuit (any of BP1 to BPn); in the second terminal 2 of each of the bypass circuits BP1 to BPn, from a relevant bypass current sensor (any of BS1 to BSn), is input a detection signal (any of IS1 to ISn) corresponding to a bypass current. And from each the terminal 3 of the comparators A1 to An through the terminal 8 of each of the current control means B1 to Bn, in each the gate (G) of the FETs is input each of control signals (any of IC1 to ICn).

On the other hand, between the power source D1 and the grounding is provided a composite current sensor (composite current detection means) CS0 for detecting a composite current IL that is a composite value of drive currents ID1 to IDn that flow in each of the laser diodes LD1 to LDn and bypass currents IB1 to IBn that flow in each of the bypass circuits BP1 to BPn; and furthermore, a composite current comparator (composite current comparison-control means) A0 for controlling the composite current IL, depending on a composite detection signal IS0 of the composite current sensor CS0, is provided and connected to the power source D0.

In other words, the composite current comparator A0 has a first terminal 1, a second terminal 2, and a third terminal 3. In the first terminal 1 is input a composite reference signal I0 corresponding to a reference value of the composite current IL that is a total of a current value flowing in each of the laser diodes LD1 to LD2 and each of the bypass circuits BP1 to BPn; in the second terminal 2, from the composite current sensor CS0 for measuring the composite current IL flowing in each of the laser diodes LD1 to LD2 and each of the bypass circuits BP1 to BPn, is input the composite detection signal IS0 corresponding to the composite current IL.

And from the output terminal 3 of the composite current comparator A0 is output a composite control signal IC0 proportional to an error between the composite reference signal I0 and the composite detection signal IS0 from the composite current sensor CS0, and the composite control signal IC0 is supplied to the power source D0. Accordingly, from the power source D0 to each of the laser diodes LD1 to LDn and each of the bypass circuits BP1 to BPn is supplied a current (that is, the composite current IL) dependent on a level of the composite control signal IC0 output from the composite current comparator A0. Thus, a negative feedback circuit is configured of the composite current sensor CS0, the composite current comparator A0, and the power source D0.

Furthermore, as shown in FIG. 1, each of optical sensors (optical detection means) OS1 to OSn is provided, corresponding to each of the laser diodes LD1 to LDn, in order to detect an output light from each of them. Meanwhile, although each of the laser diodes LD1 to LDn and each of the optical sensors OS1 to OSn are adjacently arranged, they are not electrically connected. In addition, an output terminal of each of the optical sensors OS1 to OSn is individually connected to a control circuit CNT.

In accordance with such the circuit configuration, in the control circuit CNT is performed such control as follows: with making a light signal detected by one light sensor a reference, light signals detected by other optical sensors are compared like the optical sensors OS1 and OS2, the optical sensors OS1 and OSn-1, and the optical sensors OS1 and OSn; and an output signal in accordance with each comparison result is supplied from the control circuit CNT to each of the comparators A1 to An.

In addition, in the control circuit CNT, when total excitation lights of all the laser diodes LD1 to LDn become below a predetermined value, a means for making the composite reference signal I0 supplied to the composite current comparator A0 variable is also comprised so as to increase the composite current IL, based on a comparison result between a reduced light and predetermined light. Of course, in the control circuit CNT it is assumed that a balance of a total light amount is also taken as needed by making a light output signal detected by the optical sensor OS1 a reference, and comparing it with another light output signal detected by an optical sensor corresponding to a laser diode paired with each of other optical sensors except for the optical sensor OS1.

Next, operation of the current drive device control circuit configured as in FIG. 1 will be described in detail. In FIG. 1, in order to excite a solid laser medium not shown, for example, assume that the drive current ID1 demanded for the laser diode LD1 is 30 A and the bypass current IB1 that is made to flow in the bypass circuit BP1 is 2 A. In this case a constant current of 32 A is output as a supply current from the power source D0 shown in FIG. 1. Then, in a steady state a predetermined current, 30 A, is supplied as the drive currents ID1 to IDn that flow in each of the laser diodes LD1 to LDn, and the bypass currents IB1 to IBn that flow in each of the bypass circuits BP1 to BPn are 2 A. Accordingly, a predetermined excitation light is supplied from each of the laser diodes LD1 to LDn to the solid laser medium not shown, whereby it is normally excited.

In this state the bypass currents IB1 to IBn of 2 A are detected by each of the bypass sensors BS1 to BSn, and the detection signals IS1 to ISn corresponding to the bypass currents of 2 A are output to the second input terminal 2 of each of the comparators A1 to An. On the other hand, the reference signals I1 to In corresponding to the bypass currents of 2 A are input in the first input terminal 1 of each of the comparators A1 to An from the control circuit CNT.

Therefore, since in each of the comparators A1 to An there is no error between the reference signals I1 to In of the first input terminal 1 and the detection signals 1S1 to ISn of the second input terminal 2, the control signals IC1 to ICn output from the third terminals 3 of all the comparators A1 to An are a same level. Accordingly, the FET of each of the current control means B1 to Bn holds a predetermined conductive state. Thus, the drive currents ID1 to IDn that flow in each of the laser diodes LD1 to LDn are held in the state of 30 A; and the bypass currents IB1 to IBn that flow in each of the bypass circuits BP1 to BPn are held in the state of 2 A.

On the other hand, for example, assume that although the drive current ID1 to the laser diode LD1 is 30 A, the drive current ID2 of the laser diode LD2 becomes 29 A lower than the predetermined value, 30 A, due to some kind of cause such as an occurrence of variations in a forward-direction voltage descent of the laser diode LD2. Such the descent of the drive current causes a shortage of an excitation light of the solid laser medium not shown, so it becomes an inconvenient result for the solid laser medium obtaining a predesired laser light. In such the state, since the bypass current IB2 of the bypass circuit BP2 becomes 3 A, an increment of 1 A from a predetermined current thereof, 2 A, is detected as the detection signal IS2 by the bypass current sensor BS2.

The detection signal IS2 from the bypass sensor BS2 is supplied to the second input terminal 2 of the comparator A2. Accordingly, the control signal IC2 corresponding to an error signal is supplied from the output terminal 3 of the comparator A2 to the gate of the FET configured in the current control means B2 through the terminal 8 of the current control means B2, and a negative feedback is given so as to make the bypass current IB2, which flows in the bypass circuit BP2, 2 A. As a result, the bypass current IB2 flowing in the bypass circuit BP2 becomes 2 A; and the drive current ID2 flowing in the laser diode LD2 is returned to 30 A. A1so when a change of a drive current occurs in another laser diode, the drive current flowing in a relevant laser diode is returned to 30 A by similar negative feedback operation described above.

In addition, when the bypass currents IB1 to IBn of each of the bypass circuits BP1 to BPn are reduced to a predetermined value due to some kind of cause, that is, when notwithstanding normal operation of a relevant laser diode a drive current flowing therein increases, a bypass current sensor (any of BS1 to BSn) of a relevant bypass circuit (any of BP1 to BPn) detects a reduction amount of a bypass current flowing therein and operates so as to return a current flowing in a relevant laser diode (any of LD1 to LDn) to a normal state by negative feedback operation.

Furthermore, the embodiment has a function for compensating an unbalance when it occurs in a light output of each of the laser diodes LD1 to LDn. For example, assume that the light output of the laser diode LD2 is lowered. In this case, the light output of another laser diode, for example, the light output of the laser diode LD1 and that of the laser diode LD2 are compared, and thus the control circuit CNT reduces the reference signal I2 to the comparator A2, based on the comparison result thereof.

Thus, the bypass current IB2 flowing in the bypass circuit BP2 decreases; the drive current ID2 to the laser diode LD2 relatively increases. Accordingly, an excitation light amount of the laser diode LD2 increases, whereby a balance of the light output with other laser diodes results in being held. Meanwhile, when the excitation light amount of the laser diode LD2 is much with being compared to those of other laser diodes, it will be easily understood that the balance of the light output with other laser diodes is held by decreasing the drive current ID2 of the laser diode LD2 with reverse operation described above.

In addition, when the characteristics of each of the laser diodes LD1 to LDn are deteriorated by using the solid laser apparatus over a long period, the excitation light to the solid laser medium results in totally becoming short. It is possible to handle such the state by increasing the drive currents ID1 to IDn to each of the laser diodes LD1 to LDn than an initial value. In accordance with the embodiment of the present invention, a grand total light output of each of the laser diodes LD1 to LDn is compared to a predetermined light amount, and a feedback is given from the control circuit CNT to the composite current comparator A0 so as to obtain the predetermined light amount.

In other words, when the grand total light output of each of the laser diodes LD1 to LDn is decreased, it is compared to a reference amount thereof by each of the optical sensors OS1 to OSn and the feedback of the composite reference signal I0 is given from the control circuit CNT to the first input terminal 1 of the composite current comparator A0 so as to obtain the predetermined light amount. On the other hand, in the second input terminal 2 of the composite current comparator A0 is supplied the composite detection signal IS0, from the composite current sensor CS0 for detecting the composite current IL. Therefore, an error occurs between the composite reference signal I0 and the composite detection signal IS0 due to the feedback from the control circuit CNT, and thus in response to the error, the power source D0 is instructed so as to increase the composite current IL by the composite control signal IC0 from the output terminal 3 of the composite current comparator A0. As a result, the grand total light output of each of the laser diodes LD1 to LDn becomes the predetermined light amount, and such the feedback operation continues till the feedback becomes stable. Accordingly, each excitation light is compensated so as to cover a shortage excitation by increasing a drive current that flows in each of the laser diodes LD1 to LDn.

Meanwhile, in the embodiment shown in the circuit of FIG. 1, although the detection signal IS1 to ISn, which are detection outputs thereof, are designed to be negatively feedbacked to the current control means B1 to Bn of each of the bypass circuits BP1 to BPn by detecting the bypass currents IB1 to IBn that flow in each of the bypass circuits BP1 to BPn, it may also be designed to be negatively feedbacked to the current control means B1 to Bn of each of the bypass circuits BP1 to BPn by detecting the drive currents ID1 to IDn of each of the laser diodes LD1 to LDn and comparing the detection signals IS1 to ISn with each of the reference signals I1 to In. Since it can be realized to detect the drive currents ID1 to IDn flowing in each of the laser diodes LD1 to LDn by making a circuit configuration same as in a case of current detection of each of the bypass circuits BP1 to BPn, a detailed description thereof is omitted. Meanwhile, it goes without saying that if each of the bypass currents IB1 to IBn is changed, each of the drive currents ID1 to IDn, which flows in each of the laser diodes LD1 to LDn in response to a change amount thereof, complementarily changes.

FIG. 3 is a schematic drawing showing one example of a solid laser apparatus of the present invention comprising the current drive device control circuit shown in FIG.1. Contrasting FIG. 3 with FIG. 1, a circuit portion excluding each of the laser diodes LD1 to LDn out of the current drive device control circuit in FIG. 1 is a current drive device control circuit 100 of FIG. 3. That is, the current drive device control circuit 100 of FIG. 3 includes the power source D0, the bypass circuits BP1 to BPn, the current control means B1 to Bn, the composite current sensor CS0, the bypass currents sensors BS1 to BSn, the composite comparator A0, the comparators A1 to An, the optical sensors OS1 to OSn, and the control circuit CNT, shown in FIG. 1, and only the laser diodes LD1 to LDn are excluded.

In the solid laser apparatus of FIG. 3 three laser diodes 102, 104, and 106 are serially connected to the current drive device control circuit 100, and are arranged at a same distance at a side circumference of a rod-shaped solid laser medium 8 whose sectional shape is circular. And the solid laser medium 8 is configured so as to be excided by excitation lights from the laser diodes 102, 104, and 106. In accordance with the solid laser apparatus, as described in detail in the embodiment of FIG. 1, an excitation light from each of the laser diodes 102, 104, and 106 result in being supplied to the solid laser medium 108 with being always balanced. Thus, in the solid laser medium 108 excitation operation can be performed in a high quality level.

FIG. 4 is a schematic drawing showing another example of a solid laser apparatus of the present invention comprising the current drive device control circuit shown in FIG.1. In FIG.4 a current drive device control circuit 110 includes the power source D0, the bypass circuits BP1 to BPn, the current control means B1 to Bn, the composite current sensor CS0, the bypass currents sensors BS1 to BSn, the composite comparator A0, the comparators A1 to An, the optical sensors OS1 to OSn, and the control circuit CNT, shown in FIG. 1, and only the laser diodes LD1 to LDn are excluded. Three laser diodes 112, 114, and 116 are serially connected to the current drive device control circuit 110.

In addition, three rod-shaped solid laser media 120, 122, and 124 are linearly arrayed along a laser beam axis LL, and the laser diodes 112, 114, and 116 are arranged, corresponding to side circumferences of the solid laser media 120, 122, and 124. And each of them is configured so as to be excited from corresponding each of the laser diodes 112, 114, and 116. In accordance with the solid laser apparatus, as described in detail in the embodiment of FIG. 1, an excitation light from each of the laser diodes 112, 114, and 116 result in being supplied to each of the solid laser media 120, 122, and 124 with being always balanced. Thus, in the solid laser media 120, 122, and 124 excitation operation can be performed in the high quality level.

Thus described, in the current drive device control circuit of the present invention each bypass circuit is parallely provided for a plurality of the current drive devices that are serially connected to one constant current power source. And a drive current flowing in each current drive device can be controlled by controlling a current that flows in a relevant bypass circuit.

Particularly, by using a plurality of laser diodes as a current drive device and individually controlling a drive current of each of the laser diodes depending on characteristics thereof, a solid laser medium is designed to be uniformly excited with emitting a uniform excitation light from each of the laser diodes. Thus, a suitable current drive device control circuit for a solid laser apparatus can be provided.

The embodiments are some examples for describing the present invention, and it is not limited to such the embodiments and various variations are available without departing the spirit and scope of the invention. In the embodiments the cases where the laser diodes are used as a current drive device are described, however, not limited thereto, it goes without saying that even if a general diode and a lamp are used, a similar operation/effect is obtained.

In addition, although in the embodiments control is performed to take an output balance of a light amount of each laser diode with comparing light amounts output by mutual laser diodes and detecting an unbalance amount thereof, an error from a light amount of a reference value may be made an output signal of a light unbalance by comparing the light amount of each the laser diode with that of a reference value thereof. Furthermore, there is no problem in fundamental operation of the current drive device control circuit even if the bias resistance R at the side of the source is removed. Meanwhile, there is no difference in the effect of the current drive device control circuit even if the current control means is configured of a transistor, and an IGBT (Insulated Gate Bipolar Transistor) or a complex circuit thereof instead of the FET.

What is claimed is:

1. A current drive device control circuit for controlling drive currents which flow in a plurality of current drive devices serially connected to a constant current power source, the circuit comprising:
a plurality of bypass circuits parallely connected to each of said plurality of the current drive devices,
wherein each of said plurality of the bypass circuits controls a bypass current flowing in own circuit thereof and the drive currents of said current drive devices corresponding to the bypass circuits whose bypass currents are controlled.

2. A current drive device control circuit for controlling drive currents which flow in a plurality of current drive devices serially connected to a constant current power source, the circuit comprising:
a plurality of bypass circuits parallely connected to each of said plurality of the current drive devices;
a plurality of current detection means for detecting any of a bypass current flowing in each of said plurality of the bypass circuits and a drive current flowing in each of said plurality of the current drive devices;
a plurality of comparative control means for generating a control signal by comparing a detection signal corresponding to a current detected by each of said plurality of the current detection means with a reference signal for deciding a reference level of said drive current; and
a current control means for controlling the bypass current which flows in a corresponding bypass circuit out of said plurality of the bypass circuits, based on a level of the control signal output by each of said plurality of the comparative control means.

3. A current drive device control circuit according to claim 2, the circuit comprising:
a composite current detection means for detecting a composite current of drive currents flowing in said plurality of current drive devices and bypass currents flowing in said plurality of bypass circuits; and
a composite current comparative control means for generating a composite control signal by comparing a composite detection signal corresponding to the composite current detected by said composite current detection means with a composite reference signal for deciding a reference level of said composite current,
wherein said constant current power source controls a current amount supplied to the plurality of the current drive devices, based on a level of the composite control signal output by said composite current comparative control means.

4. A current drive device control circuit according to claim 2, wherein each of said plurality of current drive devices is a laser diode.

5. A current drive device control circuit according to claim 3, wherein each of said plurality of current drive devices is a laser diode.

6. A current drive device control circuit according to claim 4 which comprises a plurality of optical detection means for individually detecting a light amount which each of said plurality of laser diodes emits, wherein at least one current control means out of said plurality of current control means is controlled, based on a level of the light amount detected by each of said plurality of the optical detection means, and wherein the relevant current control means makes a current amount of a bypass current, which flows in a corresponding bypass circuit, variable.

7. A current drive device control circuit according to claim 5 which comprises a plurality of optical detection means for individually detecting a light amount which each of said plurality of laser diodes emits, wherein at least one current control means out of said plurality of current control means is controlled, based on a level of the light amount detected by each of said plurality of the optical detection means, and wherein the relevant current control means makes a current amount of a bypass current, which flows in a corresponding bypass circuit, variable.

8. A current drive device control circuit according to claim 4, wherein said constant current power source is controlled, based on a level of a light amount detected by each of said plurality of optical detection means, and wherein a current amount supplied to said plurality of laser diodes is made variable by the relevant constant current power source.

9. A current drive device control circuit according to claim 5, wherein said constant current power source is controlled, based on a level of a light amount detected by each of said plurality of optical detection means, and wherein a current amount supplied to said plurality of laser diodes is made variable by the relevant constant current power source.

10. A current drive device control circuit according to claim 6, wherein said constant current power source is controlled, based on a level of a light amount detected by each of said plurality of optical detection means, and wherein a current amount supplied to said plurality of laser diodes is made variable by the relevant constant current power source.

11. A current drive device control circuit according to claim 7, wherein said constant current power source is controlled, based on a level of a light amount detected by each of said plurality of optical detection means, and wherein a current amount supplied to said plurality of laser diodes is made variable by the relevant constant current power source.

12. A current drive device control circuit according to claim 4, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

13. A current drive device control circuit according to claim 5, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

14. A current drive device control circuit according to claim 6, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

15. A current drive device control circuit according to claim 7, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

16. A current drive device control circuit according to claim 8, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

17. A current drive device control circuit according to claim 9, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

18. A current drive device control circuit according to claim 10, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

19. A current drive device control circuit according to claim 11, wherein each of said plurality of current control means is configured of an FET, and wherein in said FET, a drain is connected to an anode of a corresponding laser diode out of said plurality of laser diodes; a source is connected to a cathode of the relevant laser diode; and a gate is connected to an output terminal of a corresponding comparative control means out of said plurality of comparative control means.

20. A solid laser apparatus which comprises a current drive device control circuit as described in any of claims 4 to 19, wherein a plurality of laser diodes in said current drive device control circuit are arranged at a circumference of a solid laser medium, and wherein the solid laser medium is configured so as to be excited by excitation lights from the plurality of the laser diodes.

21. A solid laser apparatus which comprises a current drive device control circuit as described in any of claims 4 to 19, wherein a plurality of laser diodes in said current drive device control circuit are arranged at circumferences of a plurality of solid laser media linearly arrayed, and wherein the plurality of the solid laser media are configured so as to be excited by excitation lights from the plurality of the laser diodes.
